(19) United States
(12) Patent Application Publication
(10) Pub. No.: US 2012/0033838 A1
(43) Pub. Date: Feb. 9, 2012

(54) HEARING INSTRUMENT WITH MECHANICAL AND REMOTE-CONTROLLABLE VOLUME ADJUSTMENT

(75) Inventors: ANDREAS SPECKERT, Lamprecht (DE); HEIKE HAUERMANN, HAMBURG (DE)

(73) Assignee: SIEMENS MEDICAL INSTRUMENTS PTE. LTD., SINGAPORE (SG)

(21) Appl. No.: 13/197,809

(22) Filed: Aug. 4, 2011

Related U.S. Application Data
(60) Provisional application No. 61/370,532, filed on Aug. 4, 2010.

(51) Int. Cl. H04R 25/00

(52) U.S. Cl. 381/315; 381/321

(57) ABSTRACT

A hearing instrument, e.g. a hearing aid, has a mechanical, manually actuated volume setting element and also remote control volume adjustment. The volume setting element is a control dial with a fixed assignment of the respective rotational position to a respective volume setting. An adjustment by remote control changes the volume setting but not the position of the control dial. This results in the problem that the normally fixed assignment of the respective position of the control dial to the respective volume setting no longer holds true. If there is once again an adjustment by control dial after the volume setting was changed by remote control and the volume prescribed by the control dial is then set, unpleasant jumps in volume may therefore occur. Such jumps in volume are avoided by the following steps: detecting a change in the rotational position of the control dial, establishing a current rotational position of the control dial during the change, comparing the current rotational position to a comparison rotational position, changing the volume setting of the hearing instrument in accordance with the current rotational position only if the current rotational position has, at least momentarily, assumed the comparison rotational position.

### CROSS-REFERENCE TO RELATED APPLICATION

This application claims the priority, under 35 U.S.C. § 119(e), of provisional application No. U.S. 61/370,532, filed Aug. 4, 2010; the prior application is herewith incorporated by reference in its entirety.

### BACKGROUND OF THE INVENTION

1. Field of the Invention:

The invention relates to a hearing instrument, such as, for instance, a hearing aid, with a mechanical, manually actuated volume setting element and wherein the volume thereof can additionally also be adjusted by remote control. The invention also relates to a method for adjusting the volume of such a hearing instrument by way of the mechanical, manual volume setting element.

By way of example, hearing instruments can be designed as hearing aids. A hearing aid serves to supply a person, who has damaged hearing, with acoustic signals from the surroundings, which have been processed and amplified for compensating for or for treating the respective damage to the hearing. In principle, it consists of one or more input transducers, a signal-processing apparatus, an amplifier apparatus, and an output transducer. The input transducer generally is a sound receiver, e.g. a microphone, and/or an electromagnetic receiver, e.g. an induction coil. The output-signal generator is generally implemented as an electroacoustic transducer, e.g. a miniaturized loudspeaker, or as an electromechanical transducer, e.g. a bone-conduction receiver. It is also referred to as a receiver. The output-signal generator produces output signals that are guided to the ear of the patient and should generate a sense of hearing in the patient. The amplifier is generally integrated into the signal-processing apparatus. The hearing aid is supplied with current by a battery that is integrated into the hearing-aid casing. The essential components of a hearing aid are generally arranged on a printed circuit board as an interconnect device or connected thereto.

Other than as hearing aids, which serve to compensate for a reduced hearing, usually referred to as hearing loss, hearing instruments can also be embodied as so-called tinnitus maskers. Tinnitus maskers are used for treating tinnitus patients. They generate acoustic output signals that can contribute to reducing bothersome tinnitus or other ear noises affecting the perception and are dependent on the respective hearing impairment and, depending on operating principle, on the surrounding noise as well. In the following text, the term hearing instrument should also be understood to include tinnitus maskers and other such instruments.

Hearing aids comprise a signal-processing apparatus, the operation of which can be changed by programming or parameter setting. Operating system or firmware of the signal-processing apparatus can be programmed as software. Provision can be made for a manual or automatic selection option for selecting one of a plurality of different programmed acoustic signal-processing algorithms, which are also referred to as hearing programs. Operational parameters such as gain (volume), frequency-dependent gain spectra, frequency compression, frequency transform, noise-suppression functions, or targeted suppression of repeating or constant noise can be set. Otherwise it is possible to activate operating modes with direct reception of transmitted acoustic signals from telephones or entertainment electronics or a remote control by means of a reception coil, which is also referred to as a telecoil. Numerous further operational parameters can be thought of, which can be changed in a hearing aid.

Wireless remote controls for programming, setting operational parameters such as volume or hearing program, connection to signal sources such as a radio or telephone or for other purposes are known. An advantage of wireless remote controls, which are also known as remote control units, abbreviated RCU, consists of their simpler manual operability. Hearing aids are relatively small and setting devices on hearing aids therefore are also small and can therefore be difficult to operate. Remote controls are usually larger and can therefore have larger operating elements, e.g. buttons, that are easier to actuate.

A setting option in hearing aids, which a hearing-aid wearer usually uses a lot during everyday life, is the volume. The requirements for the volume may often change, depending on the situation and surroundings. Although these changed requirements may in part be identified automatically by the signal processing, there nevertheless remain a number of situations in which hearing-aid wearers wish to set the volume themselves.

Different setting devices are known for manually adjusting the volume on hearing aids. By way of example, non-mechanical, touch-sensitive sensors in the style of touch screens are used as volume setting elements. Use is also made of mechanical volume setting elements, which for example can be embodied as a momentary-contact switch or rocker switch. Not least, volume setting elements are known that are embodied as control dials.

In the case of volume setting elements that are embodied as control dials, a distinction can be made between two basic embodiments: “endless controllers,” which can continue to be turned without an end stop, and controllers with an end stop. In the case of endless controllers, a rotation of the controller brings about a change in the volume and the respective position of the control dial is not fixedly assigned to a specific volume setting. By way of example, endless controllers do not have a fixed, unchanging rotational position for a minimum or a maximum volume.

The lack of end stops for minimum and maximum volume is often perceived to be bothersome by hearing-aid wearers and not very intuitive in terms of its operation. In order to solve this problem, U.S. Pat. No. 7,634,097 B2 proposes that a hearing aid with an endless volume setting element produces an information signal for the hearing-aid wearer whenever the maximum or minimum volume setting is reached.

Hearing-aid wearers often consider control dials with end stops to be more comfortable and more intuitive to operate because the respective position of the control dial is fixedly assigned to a specific volume setting. By way of example, a minimum or a maximum volume setting is generally fixedly assigned to the respective end stop of the volume setting element. As a result, a hearing-aid wearer perceives e.g. the attainment of the minimum volume setting at all times, even in silent or particularly quiet situations, without an information signal needing to be generated by the hearing aid, which may be disturbing, particularly in such situations.

The volume of hearing aids that have a manually actuated control dial with an end stop can additionally often also be adjusted by remote control. An adjustment by remote control changes the volume setting but not the position of the control dial. This results in the problem that the normally fixed assignment of the respective position of the control dial to the respective volume setting no longer holds true. In this sense, the adjustment of the volume by remote control takes precedence over the setting emerging from the position of the control dial. The problem herein lies in the functionality when the control dial is once again actuated after the actuation by remote control. If the precedence of the remote control is then lifted and, instead, the setting assigned to the rotational position of the control dial is reactivated, jumps in the volume may occur. Thus, for example, if the control dial is set to maximum volume and the minimum volume was set by remote control, a subsequent actuation of the control dial would abruptly reactivate the maximum volume.

In order to avoid such jumps in volume, it is known to deactivate the control dial completely as a reaction to an adjustment of the volume by remote control. The control dial is then only reactivated after switching off or resetting the hearing aid.

### SUMMARY OF THE INVENTION

It is accordingly an object of the invention to provide a hearing device with combined mechanical and remote control volume adjustment which overcome the above-mentioned disadvantages of the heretofore-known devices and methods of this general type and which provides for hearing device with a volume setting element that is embodied as a control dial with an end stop, and a method for operating such a hearing aid, which allows a simpler, more intuitive, less problematic, and volume-jump-free manual adjustment of the volume on the control dial despite a preceding adjustment by remote control.

With the foregoing and other objects in view there is provided, in accordance with the invention, a method of adjusting a volume setting of a hearing instrument provided with a manually actuated volume setting element, wherein the volume setting element is a control dial having an associated volume setting fixedly assigned to each rotational position. The novel method comprises the following steps:
detecting a change in the rotational position of the control dial;
establishing a current rotational position of the control dial during the change;
comparing the current rotational position to a comparison rotational position; and
changing the volume setting of the hearing instrument in accordance with the current rotational position only if the current rotational position has, at least momentarily, assumed the comparison rotational position.

A basic idea of the invention consists of a method for adjusting the volume setting of a hearing instrument with a manually actuatable volume setting element, which is embodied as a control dial, in which an associated volume setting is fixedly assigned to each rotational position. According to the method, a change in the rotational position of the control dial is detected. A current rotational position of the control dial is established during the change. The current rotational position is compared to a comparison rotational position. The volume setting of the hearing instrument is thereupon changed in accordance with the current rotational position only if the current rotational position has, at least momentarily, assumed the comparison rotational position.

As soon as the control dial has assumed the comparison rotational position, a volume setting has been reached that was set in advance and therefore, in principle, is known and can be predicted. This is because, as a result of the fixed assignment of rotational position of the volume setting element and associated volume setting, it is obvious that rotational position and volume setting are so to speak equivalent. In this respect, it is also equivalent whether the rotational position or the associated volume setting is considered and used as a parameter. What the method brings about is that changes in the rotational position of the control dial only also bring about changes in the volume setting if the volume setting (or rotational position) fixed in advance is assumed. This can reliably prevent unpredictable jumps in volume and, more particularly, the selection of a suitable comparison rotational position (or a low comparison volume setting) can reliably prevent jumps in volume to loud volumes, which are particularly uncomfortable for the hearing-instrument wearer.

According to one advantageous development, that rotational position that is assigned to the lowest possible volume setting of the hearing instrument is prescribed as comparison rotational position. This ensures that possible jumps in volume only occur to low or vanishing volumes and therefore have a minimal uncomfortable effect on the hearing-instrument wearer. Advantageously, in respect of this, the hearing-instrument wearer needs no knowledge of the current volume setting of the hearing instrument. Since jumps in volume are prevented, he/she can rotate the volume setting element backward and forward without risk until said volume setting element is reactivated by reaching the required comparison rotational position.

According to a further advantageous development, that rotational position that is assigned to the current volume setting of the hearing instrument is prescribed as comparison rotational position. This ensures complete suppression of jumps in volume. This is because the volume setting element only becomes active when the rotational position thereof corresponds to the current volume setting of the hearing instrument. Metaphorically speaking, this process is similar to “capturing” or activating the volume setting element by reaching the current effective volume setting. Advantageously, in respect of this, the hearing-instrument wearer needs no knowledge of the current volume setting of the hearing instrument. Since uncomfortable jumps in volume are prevented, he/she can rotate the volume setting element backward and forward without risk until said volume setting element is reactivated by reaching the required comparison rotational position.

According to an advantageous development, firstly the volume settings that are assigned to the respective rotational positions are determined. The comparison between the current rotational position and a comparison rotational position is thereupon undertaken on the basis of a comparison of the assigned volume settings. This is expedient inasmuch as the volume setting is the relevant measure since it is precisely jumps in volume that should be avoided or at least be mitigated. By contrast, the rotational position of the control dial as such is not relevant, but only of interest to the extent that a volume setting is fixedly assigned thereto. In general, the rotational position is not known in another context either than in terms of the assigned volume setting. As a result, this constitutes a simplification and facilitation of the method if it is based on the volume setting instead of the rotational position.

According to an advantageous development, use is made of the comparison volume setting assigned to a comparison rotational position instead of this rotational position.

According to a further advantageous development, the volume setting of the hearing instrument can additionally also be adjusted by remote control, independently of the rotational position of the control dial. It is precisely when the volume is adjusted by remote control that the problem of jumps in volume described at the outset can occur if the current volume setting of the hearing instrument and the rotational position of the volume setting element do not correspond. Therefore the method can advantageously be applied, in particular, in a hearing instrument with a volume setting that can be adjusted by remote control.

With the above and other objects in view there is also provided, in accordance with the invention, a hearing instrument, such as a hearing aid, comprising:
a signal-processing apparatus having a gain that is dependent on a volume setting;
a receiver (i.e., an output-signal generator in the form of an electroacoustic transducer, an electromechanical transducer, or the like);
a control dial forming a manually actuated volume setting element, the control dial having an associated volume setting fixedly assigned to each rotational position thereof;
wherein the signal-processing apparatus and the control dial are configured to carry out the above-summarized method.

In other words, there is also provided a hearing instrument with a signal-processing apparatus with a gain that is dependent on a volume setting, with a receiver, and with a manually actuatable volume setting element, which is embodied as a control dial, in which an associated volume setting is fixedly assigned to each rotational position. The signal-processing apparatus and the control dial are embodied to carry out the advantageous method explained above.

In accordance with a concomitant feature of the invention, the hearing instrument has an RC receiver for receiving control commands from a remote control. The control commands comprise commands for adjusting the volume setting. The signal-processing apparatus, the control dial, and the RC receiver are configured to carry out the advantageous method explained above.

Other features which are considered as characteristic for the invention are set forth in the appended claims.

Although the invention is illustrated and described herein as embodied in a hearing instrument with a mechanical and remote-controllable volume adjustment, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a flowchart illustrating a method of adjusting a volume in a hearing device based on rotational positions;

FIG. 2 is a flowchart showing a method based on volume settings; and

FIG. 3 is a diagrammatic view of a hearing instrument.

### DETAILED DESCRIPTION OF THE INVENTION

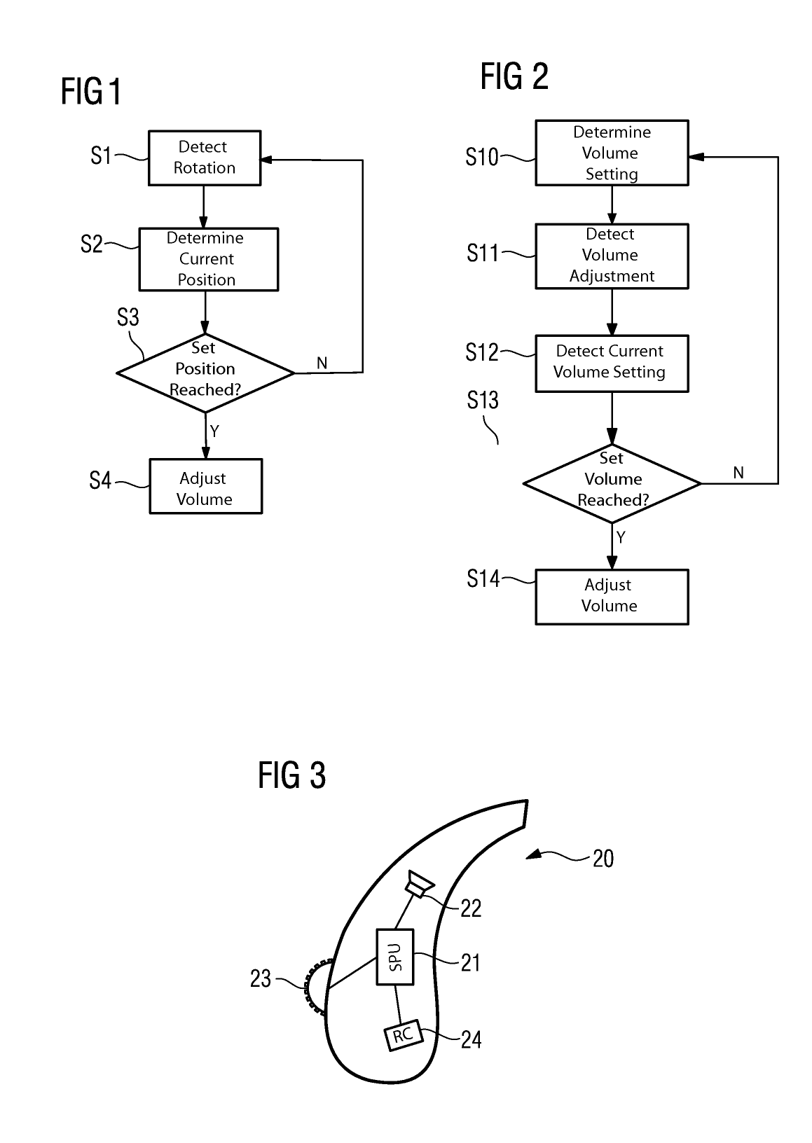

Referring now to the figures of the drawing in detail and first, particularly, to FIG. 1 thereof, there is shown a method on the basis of the rotational positions in more detail. The method is suited to be carried out in a hearing instrument with a manually actuatable volume setting element, which is embodied as a control dial, and in which a volume setting is fixedly assigned to each rotational position.

A change in the rotational position of the control dial is detected in step S1. Such a change starts the method or triggers the method procedure. In this context, in the case of hearing instruments whose volume can be changed by remote control, it should be noted that the method only need be initiated in the case of manual actuation of the control dial. Therefore, it is triggered precisely by a change in the rotational position of the control dial and not, for example, by a change in the current volume setting of the hearing instrument.

A current rotational position of the control dial is established in step S2. The current rotational position can be established on the basis of the respectively assigned volume setting. The rotational position can also be determined directly on the basis of the characteristic of an output signal of the control dial (e.g. a resistance depending on the rotational position in the case of rotary potentiometers, a code describing the respective rotational position in the case of optical control dials).

In step S3, a comparison is undertaken between the established current rotational position and a comparison rotational position. In principle, the comparison rotational position can be fixedly prescribed. By way of example, that rotational position that is assigned to a minimum volume setting may be preset as the comparison rotational position. It is also possible to prescribe a comparison rotational position that, although not being assigned to a minimum volume setting, is assigned to a low volume setting. A further particularly advantageous option consists of using the respectively current volume setting of the hearing instrument as the comparison value. The latter option is particularly advantageous because in this case an adjustment of the volume setting element always only becomes effective when the current volume setting is set as an initial point. This completely prevents jumps in volume.

If the comparison yields that the comparison rotational position has not been reached, the method restarts at step S1. By contrast, if the comparison yields that the comparison rotational position has been reached, then a change in the volume setting is undertaken in step S4 in accordance with the change in the rotational position of the volume setting element, more precisely depending on the change after the comparison rotational position was reached.

FIG. 2 illustrates a method that is analogous to the method explained above. However, it is based on the use of the volume settings instead of the respective rotational positions as work parameters. Hence the volume setting assigned to the subsequently used respective rotational position of the control dial is firstly established in step S10.

In the further steps S11 to S14, the method explained above is repeated on the basis of the volume setting instead of the rotational position. Hence, it is only briefly explained below, otherwise reference is made to the explanation above.

A change in the volume setting is detected in step S11. A current volume setting of the control dial is established in step S12. In step S13, a comparison is undertaken between the established current volume setting and a comparison volume setting. If the comparison yields that the comparison volume setting has not been reached, the method restarts at step S10. By contrast, if the comparison yields that the comparison volume setting has been reached, then a change in the volume setting is undertaken in step S14 in accordance with the change in the volume setting on the control dial, more precisely depending on the change after the comparison volume setting was reached.

FIG. 3 schematically illustrates a hearing instrument 20, which is suitable for carrying out one of the methods explained above. The hearing instrument 20 has a signal-processing apparatus 21. The signal-processing apparatus 21 is designed to emit an output signal to a receiver 22, the gain of which is dependent on the volume setting of the hearing instrument 20. A control dial 23 serves as a volume setting element. In the process, a volume setting is fixedly assigned to each rotational position of the control dial 23. Additionally, provision is made for an RC receiver 24, by means of which control commands for adjusting the volume setting can be received from a remote control.

The gain by the signal-processing apparatus 21 is dependent on both the output signal from the control dial 23 and the output signals of the RC receiver 24. Adjusting the volume by remote control does not bring about a change in the rotational position of the control dial 23. Hence there may be a discrepancy between the rotational position and the current volume setting of the hearing instrument 20, particularly in the case where the volume setting is changed by remote control.

The invention may be summarized as follows: The invention relates to a hearing instrument, e.g. a hearing aid, which has a mechanical, manually actuatable volume setting element and wherein the volume thereof can additionally also be adjusted by remote control, and also relates to a method for adjusting the volume of such a hearing instrument by means of the mechanical, manual volume setting element. The volume setting element is embodied as a control dial with a fixed assignment of the respective rotational position to a respective volume setting. An adjustment by remote control changes the volume setting but not the position of the control dial. This results in the problem that the normally fixed assignment of the respective position of the control dial to the respective volume setting no longer holds true. If there is once again an adjustment by control dial after the volume setting was changed by remote control and the volume prescribed by the control dial is then set, unpleasant jumps in volume may therefore occur. Hence, the object of the invention consists of avoiding such jumps in volume. This is brought about by the following steps: S1 detecting a change in the rotational position of the control dial, S2 establishing a current rotational position of the control dial during the change, S3 comparing the current rotational position to a comparison rotational position, S4 changing the volume setting of the hearing instrument in accordance with the current rotational position only if the current rotational position has, at least momentarily, assumed the comparison rotational position.

1. A method of adjusting a volume setting of a hearing instrument provided with a manually actuated volume setting element, wherein the volume setting element is a control dial having an associated volume setting fixedly assigned to each rotational position, the method which comprises:
detecting a change in the rotational position of the control dial;
establishing a current rotational position of the control dial during the change;
comparing the current rotational position to a comparison rotational position; and
changing the volume setting of the hearing instrument in accordance with the current rotational position only if the current rotational position has, at least momentarily, assumed the comparison rotational position.

2. The method according to claim 1, wherein the comparison rotational position corresponds to a rotational position that is assigned to a lowest possible volume setting.

3. The method according to claim 1, wherein the comparison rotational position corresponds to a rotational position that is assigned to the current volume setting of the hearing instrument.

4. The method according to claim 1, which comprises, in a first step determining the volume settings that are assigned to the respective rotational positions and then comparing the current rotational position and a comparison rotational position based on a comparison of the assigned volume settings.

5. The method according to claim 4, which comprises using the comparison volume setting assigned to a comparison rotational position instead of the rotational position.

6. The method according to claim 1, wherein the hearing device is also provided with a remote control volume setting and the volume setting is adjustable by remote control independently of the rotational position of the control dial.

7. A hearing instrument, comprising:
a signal-processing apparatus having a gain that is dependent on a volume setting;
a receiver;
a control dial forming a manually actuated volume setting element, said control dial having an associated volume setting fixedly assigned to each rotational position thereof;
wherein said signal-processing apparatus and said control dial are configured to carry out the method according to claim 1.

8. The hearing instrument according to claim 7, which further comprises an RC receiver for receiving control commands from a remote control, wherein the control commands comprise commands for adjusting the volume setting, and wherein said signal-processing apparatus, said control dial, and said RC receiver are configured to carry out the method according to claim 6.
